(19) United States
(12) Patent Application Publication
(10) Pub. No.: US 2003/0172001 A1
(43) Pub. Date: Sep. 11, 2003

(54) Information providing system, information providing method, storage medium and program

(76) Inventors: Masataka Yasuda, Kanagawa (JP); Shigeo Yamagata, Kanagawa (JP); Shinichi Kato, Kanagawa (JP); Shozo Yamasaki, Kanagawa (JP); Reiji Misawa, Tokyo (JP)

Correspondence Address: ROBIN BLECKER & DALEY, 2ND FLOOR, 330 MADISON AVENUE, NEW YORK, NY, 10017, US

(21) Appl. No.: 10/376,514

(22) Filed: Feb. 28, 2003

(30) Foreign Application Priority Data
Mar. 6, 2002 (JP) 060440/2002
Mar. 6, 2002 (JP) 060441/2002

(51) Int. Cl. G06F 17/60

(52) U.S. Cl. 705/26

(57) ABSTRACT

An information providing system capable of sending and receiving electronic data from a server in which the electronic data is registered includes a delivering unit for delivering electronic data registered in the server, a connecting unit for connecting a portable device possessed by an individual to a communication network for communicating electronic information, a sending unit for sending information for identifying an individual stored in the portable device, an authenticating unit for receiving the information for identifying an individual sent from the sending unit, and determining whether or not the delivering unit is available to a user, and a registering unit for receiving a password or ID information required when a user acquires electronic data by the delivering unit, and registering the password or ID information in the portable device possessed by. the individual.

### BACKGROUND OF THE INVENTION

1. Field of the Invention

The present invention relates to a system capable of, when a user acquires electronic data via a network, simply authenticating the user for receiving a delivery service of the electronic data, easily searching the electronic data, and acquiring the electronic data.

2. Description of Related Art

There has been spread a service in which information printed on a magazine or the like, music data recorded in a medium such as CD is delivered as electronic data via the Internet widely used in recent years.

So far, a user visits a retailing store to purchase sheets to which information is recorded or a medium such as CD. On the contrary, the user connects his/her personal computer to a communication network such as the Internet, and accesses a server into which character information converted into electronic data or music information converted into a standardized format such as MP3 is recorded to download information stored therein.

When the user downloads the electronic data from the Internet or the like, since the user receives the delivery service of the electronic data, it is required to send personal information for identifying the user.

At this time, there occurs a trouble in which the user uses a keyboard or the like to send personal information each time.

Also, there is a problem that the amount of information which an individual has to send in order to acquire the service is different depending on a provider which manages the server providing the delivery data, or a method for inputting the information is not unified. Further, with respect to the charge required for receiving the service, a credit card number or a password sometimes has to be sent so that the individuals have to memorize the respective passwords. In addition, there is a problem that the user has to manage the information such as the password required for acquiring the electronic data sent from the delivery server in order to acquire the electronic data.

Further, there is a problem that, when the user outputs the data not from a personal computer at home but from a printer installed in, for example, a convenience store for acquiring the electronic data, an operation method is different depending on a printer device, and it takes times to input the password or the personal information from the printer or the like installed in the convenience store.

Furthermore, so far, when the user wants to download the electronic data from the server present over the communication network such as the Internet and output it on a recording medium such as sheet by using a multi-function peripheral (MFP) on which a printer and a scanner are mounted installed in a convenience store, the multi-function peripheral (MFP) installed in the convenience store is required to be connected to the communication network such as the Internet so that the user has to visit a specific place where the MFP connected to the communication network such as the Internet is installed to perform operation.

### SUMMARY OF THE INVENTION

The present embodiment has been made in order to solve the above problems, and an object of the invention is to provide a system capable of sending and receiving electronic data via a communication network for communicating electronic information, comprising a portable device connectable to the communication network, information outputting means capable of outputting information on a sheet, a monitor or the like, connecting means for connecting the portable device to the information outputting means, deciding means for deciding whether or not the information outputting means is directly connectable to the communication network, and switching means for, when the deciding means decides that the information outputting means is directly connected to the communication network, acquiring electronic data from the communication network, and for, when the deciding means decides that the information outputting means is not directly connected to the communication network, switching a mode to acquire electronic data from the communication network via the portable device.

In order to solve the above problems, another object of the invention is to provide an information providing system capable of sending and receiving electronic data from a server in which the electronic data is registered, comprising delivering means for delivering electronic data registered in the server, connecting means for connecting a portable device possessed by an individual to a communication network for communicating electronic information, sending means for sending information for identifying an individual stored in the portable device, authenticating means for receiving the information for identifying an individual sent from the sending means, and determining whether or not the delivering means is available to a user, and registering means for receiving a password or ID information required when a user acquires electronic data by the delivering means, and registering the password or ID information in the portable device possessed by the individual.

Other objects and features according to the present invention will be apparent from the following drawings and specification.

### BRIEF DESCRIPTION OF THE DRAWINGS

FIG. 1 is a schematic diagram showing an information providing method and a management authentication system;

FIG. 2 is a schematic diagram showing a MFP;

FIG. 3 is a detailed explanatory diagram showing an electric process unit of a printer unit;

FIG. 4 is a detailed explanatory diagram showing an electric process unit of a scanner unit;

FIG. 5 is a schematic diagram showing communication during authentication process;

FIG. 6 is a schematic diagram showing a portable device;

FIG. 7 is a schematic diagram showing information stored in a RAM in a portable device;

FIG. 8 is a schematic diagram showing communication when acquiring electronic data;

FIG. 9 is a schematic diagram showing an information providing method and a management authentication system;

FIG. 10 is a schematic diagram showing communication during authentication process;

FIG. 11 is a schematic diagram showing communication when acquiring electronic data;

FIG. 12 is a diagram showing a configuration of a typical computer;

FIG. 13 is a flow chart showing operations of a CPU of a printer unit;

FIG. 14 is a schematic diagram showing communication during authentication process; and

FIG. 15 is a schematic diagram showing communication during authentication process.

### DETAILED DESCRIPTION OF THE PREFERRED EMBODIMENTS

(First Embodiment)

In the present embodiment, description will be made assuming that a user utilizes a multi-function system on which a printer, a scanner function, and the like are available installed in a convenience store or the like to acquire electronic data from a delivery server present on a communication network such as the Internet.

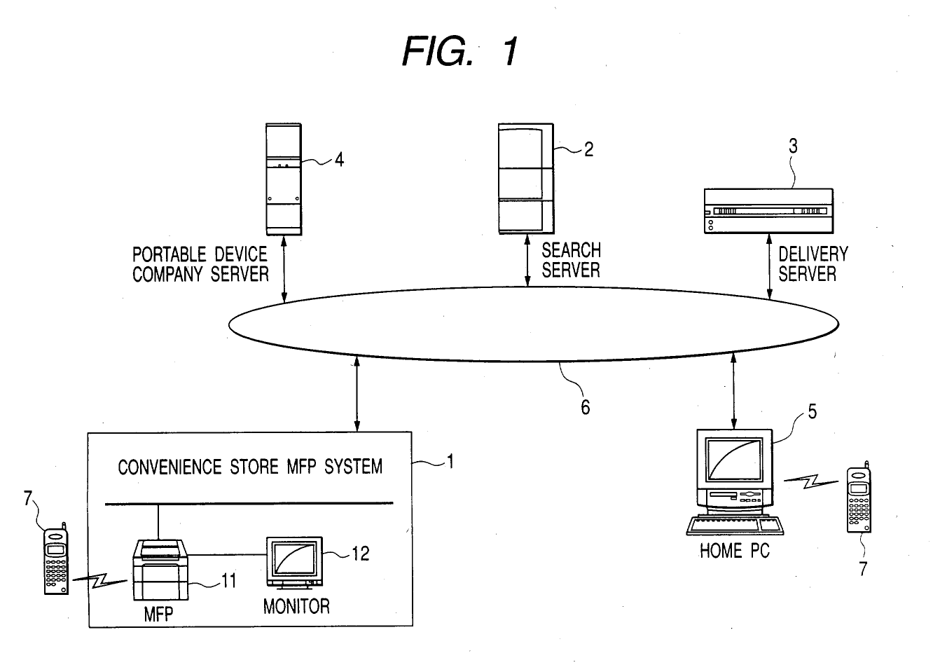

FIG. 1 is a schematic diagram showing an outline of a system according to one embodiment of the present invention.

In FIG. 1, numeral 1 denotes a multi-function system (hereinafter, denoted as MFP system) installed in a convenience store or the like, 2 denotes an information search server, 3 denotes a delivery server which stores electronic data desired by a user therein, 4 denotes a service server for a portable device or the like which processes charge when the user uses a service, 5 denotes a home personal computer used by the user who uses the MFP, 6 denotes a communication network such as the Internet, and 7 denotes a portable device with a communication function such as portable phone used by the user.

The MFP system installed in a convenience store or the like is configured with a MFP 11, a CRT monitor 12 having a printer, a scanner, or a copying function. Numeral 14 denotes a local area network within the convenience store, where, for example, a plurality of MFPs are connected to the local area network. Further, the CRT 12 is connected to the MFP 11.

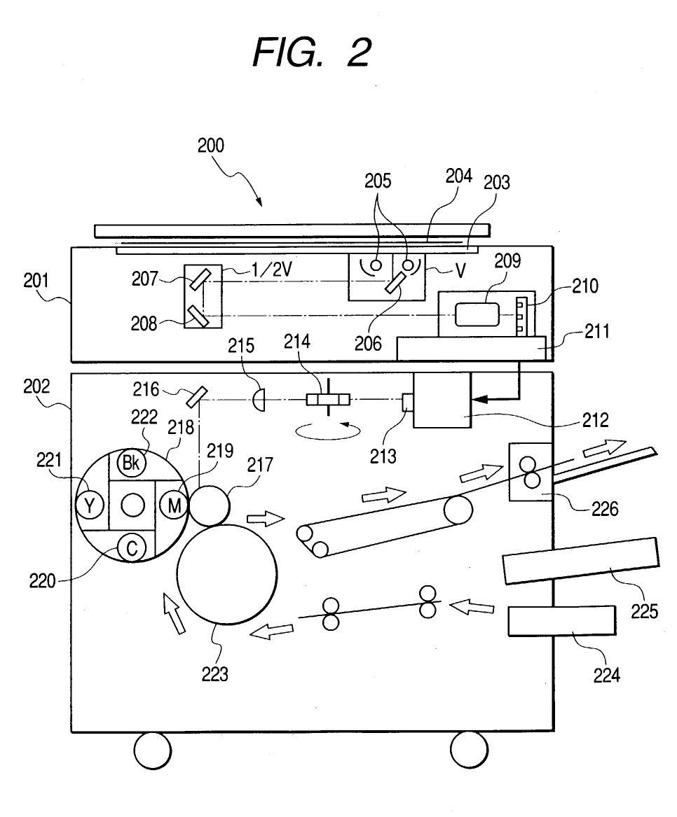

FIG. 2 is a side section view showing a configuration of a digital copying machine 100 according to the present invention.

In FIG. 2, numeral 200 is roughly divided into an image reader unit 201 for reading an original image and a printer unit 202 for reproducing image data read by the image reader unit 201.

The image reader unit 201 reads an original with a resolution of 400 dpi (dots/inch) and performs digital signal process. The printer unit 202 outputs the image corresponding to the original image read by the image reader unit 201 to a designated sheet with a resolution of 400 dpi in a full color print.

In the image reader unit 201, an original 204 on an original pedestal glass (hereinafter, denoted as platen) 203 is radiated by a lamp 205, and is guided to mirrors 206, 207 and 208, where an image is formed on a 3-line sensor (hereinafter, denoted as CCD) 210 for converting a converged light into an electric signal by a lens 209 to be sent to a signal process unit 211 as full-color information of red (R), green (G), and blue (B) components.

A carriage which fixes the lamp 205 and the mirror 206 and a carriage which fixes the mirrors 207 and 208 are mechanically moved in the vertical direction relative to an electric scanning (main scanning) direction of the line sensor at the speed of V and at the speed of ½V, respectively, so that the overall surface of the original is scanned (sub-scanned).

The signal process unit 211 electrically processes the read image signal, decomposes it into the respective components of magenta (M), cyan (C), yellow (Y), and black (Bk), and sends them to the printer unit 202.

One component of M, C, Y, and Bk is sent to the printer unit 202 per one original scanning in the image reader unit 201 so that one printout is completed by four times of original scanning in total. Each image signal of M, C, Y, Bk sent from the image reader unit 201 is sent to a laser driver 212. The laser driver 212 modulation-drives a semiconductor laser 213 according to the sent image signal. A laser light scans over a photosensitive drum 217 through a polygon mirror 214, an f-θ lens 215, and a mirror 216.

Numeral 218 denotes a rotating developer which is configured with a magenta developing unit 219, a cyan developing unit 220, a yellow developing unit 221, and a black developing unit 222, where the four developing units alternately contacts the photosensitive drum 217 so that a potential image formed on the photosensitive drum is developed by toners. 223 denotes a transfer drum which winds a sheet supplied from a sheet cassette 224 or 225 on the transfer drum 223 so as to transfer the image developed on the photosensitive drum to the sheet. In this manner, after four colors of M, C, Y, and Bk are sequentially transferred, the sheet passes through a fixing unit 226 to be discharged after the toners are fixed on the sheet.

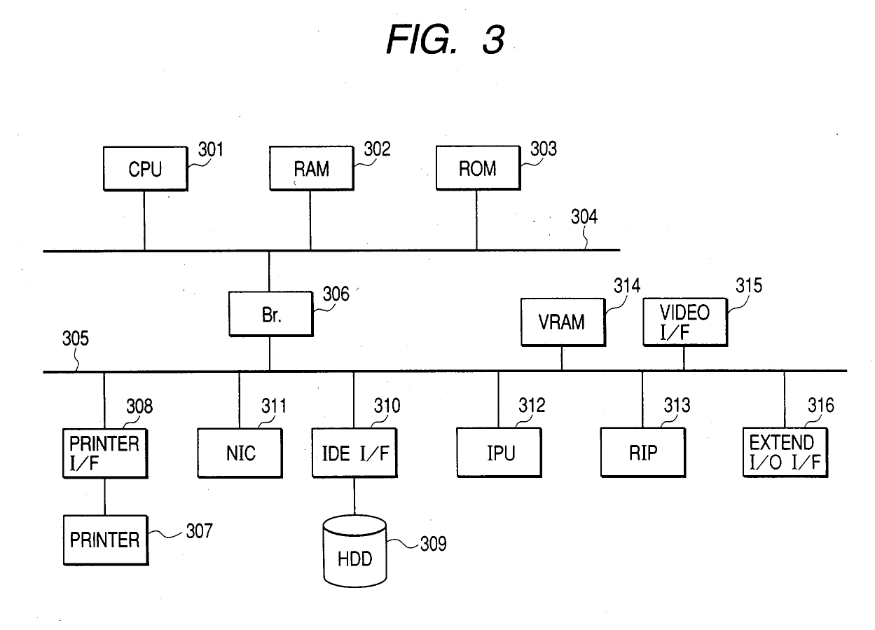

FIG. 3 shows in detail a configuration of a portion for processing an electric signal of the printer unit for printing on a recording medium such as sheet in the MFP 11.

Numeral 301 denotes a CPU for controlling respective units of the printer. Numeral 302 denote a RAM for temporarily storing results calculated by the CPU, image data handled by the printer, and the like. Numeral 303 denotes a ROM in which a program for operating the CPU, font data for producing image data, and the like are stored. Numeral 304 denotes a local bus via which the CPU, RAM, and ROM are connected.

Numeral 305 denotes an I/O bus which is an internal bus for function expansion. Numeral 306 denotes a bridge circuit for connecting the local bus and the I/O bus. Numeral 307 denotes a printer unit for forming an image on a recording medium such as sheet. Various types of printer unit such as electrophotographic type and bubblejet (R) type are present.

Numeral 308 denotes a printer interface unit for connecting the printer unit and the I/O bus and capable of transferring the image data stored in the RAM 302 to the printer unit 307 according to an instruction of the CPU. Numeral 309 denotes a hard disk drive in which a program for performing spool of the image data or performing various processes by the CPU 301 is stored. Numeral 311 denotes a network interface controller used for being connected to the local area network 14 in FIG. 1.

Numeral 312 denotes an image process unit (hereinafter, denoted as IPU) for performing an image process such as resolution conversion. Numeral 313 denotes a raster image processor used for expanding image data of a page description language transferred from externally via the network interface circuit 311 into a bitmap image according to an instruction of the CPU 301 and for storing the expanded bitmap data in the RAM 302.

Numeral 314 denotes a video RAM into which display data displayed on an external CRT or LCD panel is written by the CPU. Numeral 315 denotes a video interface for interfacing in order to display the display data stored in the VRAM on the external CRT or LCD panel.

Numeral 316 denotes an expansion I/O interface which is an interface circuit by which the CPU 301 performs communication with, for example, a portable device. The communication form includes a serial communication, a wireless communication such as bi-centronic interface or Bluetooth, and the like.

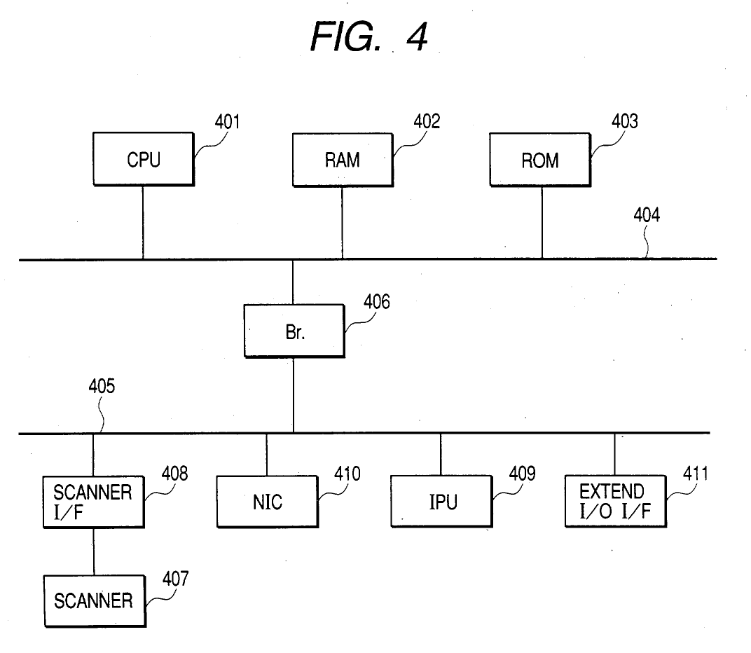

FIG. 4 shows in detail a configuration of a portion for processing an electric signal of the scanner unit in the MFP 11.

Numeral 401 denotes a CPU for controlling the respective units of the scanner. Numeral 402 denotes a RAM for temporarily storing results calculated by the CPU or image data read by the scanner. Numeral 403 denotes a ROM in which a program for operating the CPU or the like is stored. Numeral 404 denotes a local bus by which the CPU, RAM, and ROM are connected. Numeral 405 denotes an I/O bus which is an internal bus for function expansion. Numeral 406 denotes a bridge circuit for connecting the local bus and the I/O bus. Numeral 407 denotes a scanner unit for converting a signal optically read from the original placed on the platen (not shown) into electronic data using the CCD or the like and transferring the electronic data. Numeral 408 denotes a scanner interface unit for connecting the scanner unit and the I/O bus and capable of transferring the electronic data obtained by reading the original transferred from the scanner to the RAM 402.

Numeral 410 denotes a network interface controller used for being connected to the local area network 14 in FIG. 1. Numeral 409 denotes an image process unit (hereinafter, denoted as IPU) for performing image process such as resolution conversion. Numeral 411 denotes an expansion I/O interface which is an interface circuit by which the CPU 401 performs communication with, for example, a portable device. The communication form includes a serial communication, a wireless communication such as bi-centronic interface or Bluetooth, and the like.

The above MFP in FIG. 1 can be connected to an outside communication network 6 such as the Internet via the local area network 14.

Various servers are connected over the communication network 6 such as the Internet, where there are present a search server 2 for searching information, a delivery server 3 capable of accumulating electronic data and performing a service of delivering the electronic data held inside in response to a user request, and a server 4 for performing various services for a portable device such as portable phone, or a portable device service capable of performing charge control.

The MFP in FIG. 1 can make an inquiry about information to the search server 2 via the communication network 6 such as the Internet by a predetermined operation by the user. Further the data received from the search server can be printed out in the monitor 12 or the MFP 11 in FIG. 1.

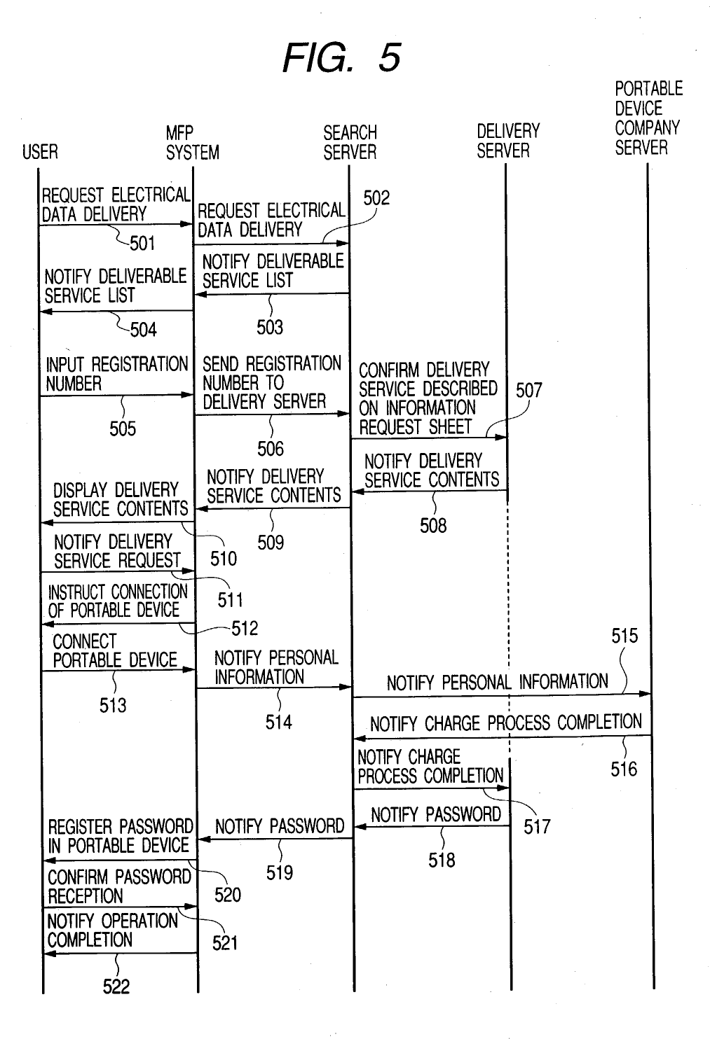

FIG. 5 is a diagram for explaining an outline of the operation where the user uses the MFP system 1 in FIG. 1 installed in a convenience store or the like, utilizes the search server 2 connected over the communication network 6 such as the Internet to search the delivery server 3 in which the electronic data of information desired by the user is accumulated, and is charged the utilization fee for the information reception on a portable device company server so as to acquire a password for acquiring the electronic data.

The user uses and operates the MFP 1 to input the deliverable service contents at a place such as convenience store where the MFP system 1 is installed (501).

The MFP 1 which has received the inquiry about the deliverable service of the electronic data from the user makes an inquiry to the search server 2 in FIG. 1 (502).

In order that a magazine company or a provider which intends to place advertisements or information on a medium such as magazine provides more detailed information or high degree services using the environment such as the Internet, when the key code is also placed on the medium such as magazine, at first application is performed for an organization which manages the search server 2 in FIG. 1. Thereby, the organization which manages the search server 2 at first issues a service registration number by which the magazine company or the provider which intends to place advertisements or information on a medium such as magazine identifies the services provided on the environment such as the Internet.

When an inquiry about the electronic data delivery service is made from the MFP 1 installed in a convenience store or the like, the search server 2 returns the registration number together with the service contents (503).

The MFP which has received the service contents and this registration number from the search server 2 displays the sent service contents and the registration number corresponding to the service on the monitor 12 or the like in FIG. 1.

Next, when the desired electronic data is contained in the service contents sent from the search server 2, the user inputs the registration number corresponding thereto by operating. the MFP 1 (505).

Next, the MFP 1 uses the URL of the search server 2 to send the registration number input by the user via the environment such as the Internet network 6 or the like to the search server 2 (506).

The search server 2 which has received the service registration number from the MFP 1 searches information of the delivery server 3 providing the service by the received registration number.

The search server 2 reads the delivery server information corresponding to the service registration number stored therein. The URL information of the delivery service 3 providing the service, or the like is accumulated in the search server so that, after the URL information of the delivery server 3 is detected from the searched information, the search server 2 sends an inquiry about the service presence to the delivery server 3 via the Internet network 6 or the like (507).

The delivery server 3 which has received the inquiry about the service presence from the search server 2 returns a message that the information delivery is available, and further returns charge information required for the information delivery (508).

The search server 2 which has received the message that the delivery service is available from the delivery server 3 notifies the MFP system 1 that the information delivery service is available (509).

The MFP 1 which has been notified that the delivery service is available from the search server 2 outputs a message that the information is available to a user on the monitor 12 in FIG. 1.

When the user operates the MFP 1 to input a message that he/she will continue the utilization operation of the delivery service (511), the MFP 1 outputs a screen which requests the user to connect a portable device possessed by the user to the MFP 1 on the monitor 12 (512).

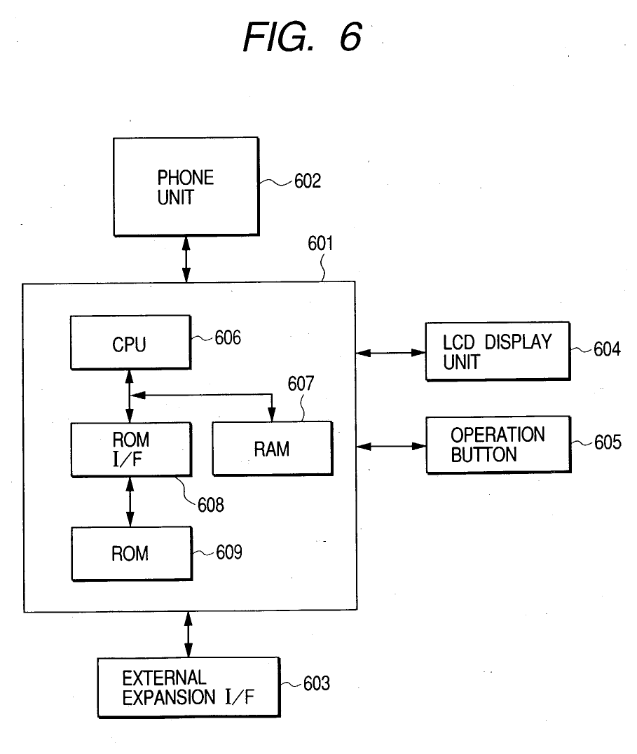

FIG. 6 is a block diagram showing an outline of a portable device. The portable device, to which a LCD display unit 604 and an operation unit 605 are connected like a portable phone, has a phone unit 602 for functioning as a phone. A CPU 606 for controlling the entire device is mounted on a central unit 601 of the phone unit 602, and a RAM 607 is connected thereto as a temporary storage by which the CPU operates.

Further, a ROM 609 having personal information stored therein is mounted, where a phone number or ID information by which the portable device company identifies an individual is stored. The ROM 609 is connected to the CPU via a ROM I/F 608, and only the ROM 609 is detachable as needed.

The portable device has an external expansion I/F 603 so that it can be communicated with other device by mounting a wireless I/F such as infrared communication. In the present embodiment, the external expansion I/F can be connected to the MFP 1 to be used as the I/F for sending and receiving information.

In addition, it is possible to mount an IC card or the like to the external expansion I/F so that personal information or information used by the user can be stored not in the ROM 609 or the RAM 607 inside but in the IC card.

When the user connects the portable device to the MFP 1 according to an instruction of the MFP 1, the MFP 1 reads the phone number of the portable device stored in the ROM 609 in the connected portable device or the ID individually managed per portable device.

At this time, information on the company which manages and operates the portable device service is also extracted simultaneously (513).

At this time, it is also possible to mount a scanner for reading a fingerprint on the external expansion I/F 603 of the portable device, and to send personal fingerprint information together with the personal data.

The personal information read by the MFP 1 and stored in the portable device is transferred to the search server 2 via the Internet network 6, and the information on the company which manages and operates the service for the portable device is also transferred (514), so that the URL information of the server which performs the service for the portable device is searched on the basis of this information.

The search server 2 sends the personal information acquired from the portable device to the portable device company server from the searched URL via the Internet network 6, and inquires the personal information to confirm whether he/she is a person regally registered in the portable device company (515).

At this time, when the scanner for reading living body information such as fingerprint is mounted on the external expansion I/F 603, the personal fingerprint information is also received so that it is possible to identify the individual with both the portable device information and the fingerprint information.

After it is confirmed that the portable device is registered in the portable device company, the charge for delivering the electronic data from the delivery server 3 is requested to the portable device company server.

The portable device company is notified the information on the delivery server connected to the Internet network 6 from the search server 2 and receives charge information when utilizing the service provided by this delivery server. Thereafter, the company transfers the utilization fee for the service to the bank account of the magazine company which manages and operates the delivery server 3 or the provider which intends to place advertisements or information on a medium such as magazine.

The fee which the portable device company transferred for the magazine company which manages and operates the delivery server or the provider which intends to place advertisements or information on a medium such as magazine is charged as the portable device service utilized by the user, which is transferred later to the bank account of the company which operates the portable device service from the user.

As described above, at the stage of the charge process completion in the portable device company, the portable device company server 4 notifies the search server 2 of the charge process completion (516).

Next, the search server 2 notifies the delivery server 3 of the charge process completion via the Internet network 6 or the like, and requests to continue the electronic data delivery service (517).

The delivery server 3 which has received the charge process completion for the delivery service generates a password for permitting to transfer the electronic data stored in the delivery server 3 via the Internet network 6 or the like, and sends the password information to the search server 2 (518).

Further, in order to specify the user who has performed a series of operations when the delivery server issues the password, the delivery server issues an arbitrarily assigned ID and specifies the user who has utilized the service by this ID on the delivery server.

The delivery server 3 sends this ID information in addition to the password to the search server 2.

The search server 2 which has received the password information retransfers the password to the MFP system 1 (519).

The MFP system 1 which has received the password transfers the password information and a communication log between the search server 2, the delivery server 3, and the portable device company server to the user's portable device being connected (520).

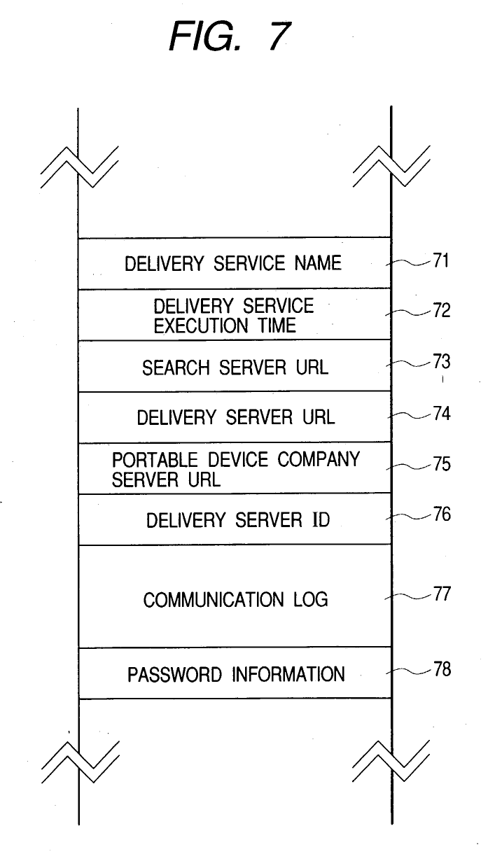

FIG. 7 shows an outline of information transferred to a memory of the ROM 607 in the portable device.

The information transferred to the portable device to which the MFP is connected includes a name (71) of electronic data to be delivered which is desired by the user, the URL (73) of the search server 2 connected to the communication network 6 such as the Internet in FIG. 1 used for utilizing the service, the URL (73) of the delivery server 3 which provides the service, and the URL (74) of the portable device company server which has performed the charge process.

Further, the ID information sent to the MFP, which the delivery server 3 has arbitrarily assigned, is also stored here (76).

The date and time at which the electronic data delivery service is utilized is also stored (72). The password for acquiring the electronic data from the delivery server is also stored (76).

In addition, history information related to the communication such as information of a router used for connecting to the Internet is stored as a communication log on the RAM 607 in the portable device from a product number of the utilized MFP or the local area network in the convenience store in FIG. 1 (78).

After the MFP system 1 transfers a series of information including the password to the user's portable device, the user operates the MFP system to notify the password confirmation to the MFP 1 (521). The MFP 1 then outputs a message that all the processes have been completed to the monitor 12 and completes all the operations (522).

Next, description will be made in detail on the case where the user acquires the electronic data from the delivery server 3 using the user's personal computer 5.

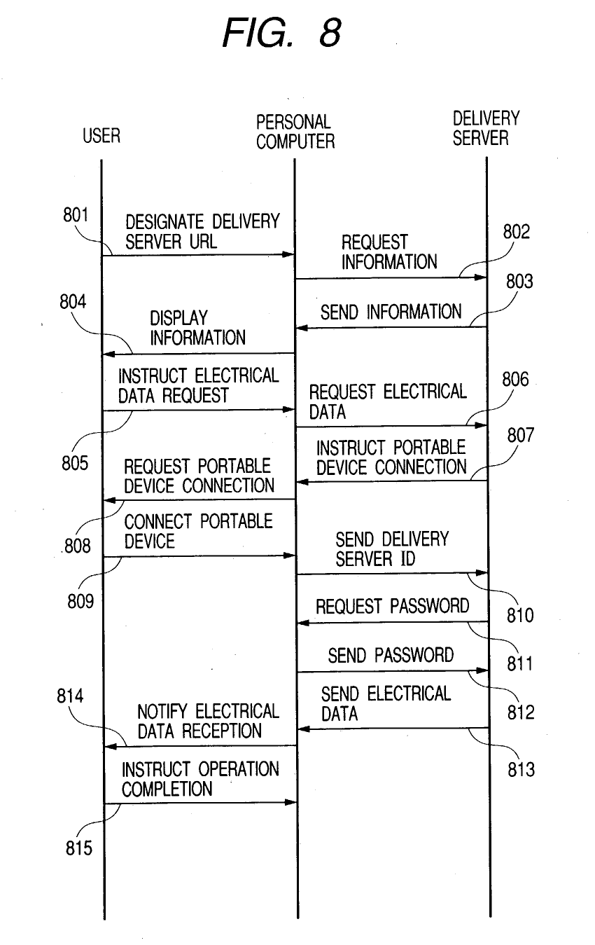

FIG. 8 is shown for explaining an outline of the operation where the electronic data of the information desired by the user is transferred from the delivery server 3 to the user's personal computer 5 according to one embodiment of the present invention.

First, the user activates the personal computer 5 and operates an application software accessible to a server over the Internet, and then inputs the URL of the delivery server 3 (801).

The personal computer 5 which is designated the URL makes access to the delivery server 3 via the communication network 6 such as the Internet (802).

The delivery server 3 which has been accessed by the personal computer 5 sends public information, in particular the delivery service information of the electronic data to the personal computer 5 (803).

The personal computer 5 outputs the information received from the delivery server 3 on the monitor or the like to prompt the user to continue the operation (804).

Next, the user uses a keyboard or mouse of the personal computer to request the electronic data delivery on the basis of the information output on the monitor of the personal computer 5 (805).

The personal computer 5 which has received a reception request of the delivery data from the user requests the electronic data delivery to the delivery server 3 via the communication network 6 such as the Internet (806).

The delivery server 3 which has been requested the electronic data delivery requests the portable device connection to the personal computer which has requested the electronic data (807).

The personal computer 5 which has been requested the portable device connection from the delivery server 3 outputs an instruction of the portable device connection to the monitor or the like, and prompts the user to connect the portable device to the personal computer (808).

Next, the user receives the password from the delivery server 3 in advance, and connects the portable device stored in the internal RAM 607 to the personal computer 5.

Since the portable device has the external expansion I/F 603 as described above, an optional portion such as IrDA or Bluetooth is attached thereto so that a communication with an external device is enabled.

The personal computer described in the present embodiment comprises an external communication I/F such as IrDA so that a communication with the portable device is possible. The portable device is prepared to be connectable via IrDA, and then the user notifies the completion of the portable device connection to the personal computer 5 (809).

The personal computer 5 to which the portable device is connected searches the name 71 of the electronic data which is a delivery service target shown in FIG. 7 and which is stored in the RAM 607 in the portable device.

The personal computer 5 which has searched the name of the electronic data which is the delivery service target reads the ID information (76) which is next written and which the delivery server 3 has arbitrarily assigned, and sends the ID information (76) to the delivery server 3 via the communication network 6 such as the Internet (810).

The delivery server 3 which has received the ID information (76) confirms the history of the ID issued before being stored in the delivery server 3, and confirms the password corresponding to the ID, and then requests the password to the personal computer 5 (811).

The personal computer 5 which has been requested the password from the delivery server reads the password (76) from the RAM 607 in the connected portable device being connected and sends it to the delivery server 3 (812).

The delivery server 3 which has received the password from the personal computer 5 inquires the password stored in the delivery server 3 corresponding to the ID information (76) as described above, when the password matches, the electronic data is sent to the personal computer 5 (813).

The personal computer 5 which has completed the electronic data reception from the delivery server 3 notifies the monitor of the electronic data reception (814), and the user notifies the personal computer of the operation completion, and completes all the operations (815).

In such a manner, according to the present embodiment, the user can cause the electronic data delivery operation to be performed without being conscious of the password information.

Further, the user can automatically acquire the delivery information without being conscious of the electronic data name for acquiring the delivery information or the operation request for the delivery server.

Also, the user uses the electronic data delivery information once input in the user's portable device so that it is possible to download the electronic data desired by the user from anywhere by utilizing all the things which are connectable with the portable device and are connected to the communication network such as the Internet without performing complicated authentication process.

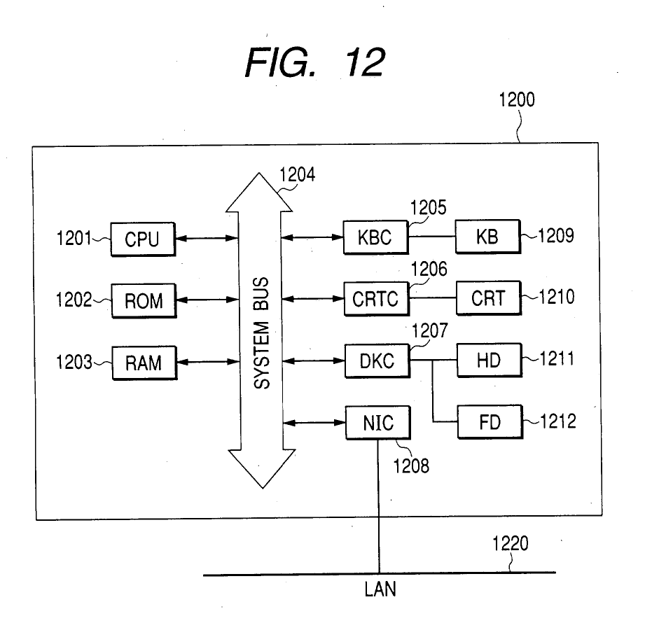

The personal computer 5 may be typical as shown in FIG. 12. FIG. 12 is a diagram showing an internal configuration of a typical personal user device. In FIG. 12, numeral 1200 denotes a computer PC. The PC 1200 comprises a CPU 1201, and executes a device control software stored in a ROM 1202 or a hard disk (HDD) 1211 or supplied by a flexible disk drive (FD) 1212 to control each device connected to a system bus 1204 as a whole.

A function of each means according to the present embodiment is realized by a program stored in the CPU 1201, ROM 1202, or hard disk. (HD) 1211 of the PC 1200.

Numeral 1203 denotes a RAM, which functions as a main memory, a work area, or the like of the CPU 1201. Numeral 1205 denotes a keyboard controller (KBC), which controls instruction inputting from a keyboard (KB) 1209, a device (not shown) or the like.

Numeral 1206 denotes a CRT controller (CRTC), which controls display of a CRT display (CRT) 1210. Numeral 1207 denotes a disk controller (DKC), which controls access with the hard disk (HD) having a boot program (activation program: program for initiating execution (operation) of hardware or software of the personal computer), a plurality of applications, an edition file, a user file, a network management program, and the like stored therein, and the flexible disk (FD) 1212.

Numeral 1208 denotes a network interface card (NIC), which exchanges bidirectional data with a network printer, other network devices, or other PCs through the LAN 1220.

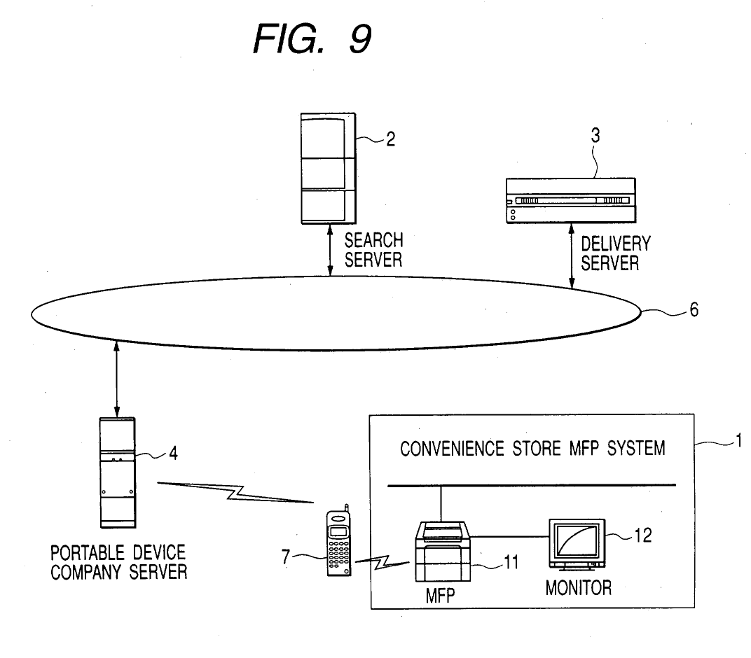

(Second Embodiment) FIG. 9 is a schematic diagram showing an outline of a system according to a second embodiment of the present invention.

The second embodiment differs from the first embodiment in that the MFP 11 installed in a convenience store or the like is not connected to the communication network 6 such as the Internet.

Further, in the second embodiment according to the present invention, description will be made assuming that the delivery data desired by the user is received at the MFP installed in a convenience store or the like to be output on a medium such as sheet from the MFP.

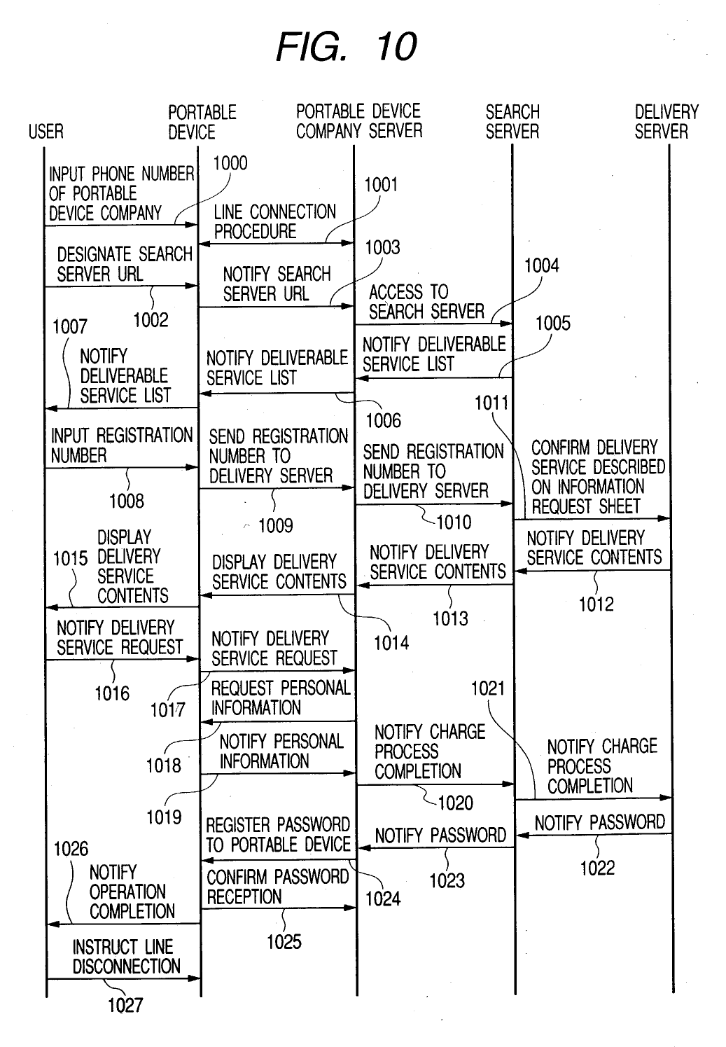

FIG. 10 is shown for explaining an outline of the operation where the user uses the portable device 7 to communicate with the portable device company server 4 utilizing a digital telephone line, uses the search server 2 via the communication network 6 such as the Internet to search the delivery server 3 which accumulates the electronic data of the information desired by the user therein, and further is charged the utilization fee for receiving the information on the portable device company server so as to acquire the password for acquiring the electronic data in the second embodiment according to the present invention.

First, the user inputs a phone number of the portable device company and makes connection to the portable device company server 4 (1000). The portable device 7 whose phone number has been input performs a procedure for connecting a predetermined line with the portable device company server 4 (1001), and completes the line connection.

Next, the user inputs the URL of the search server 2 connected over the communication network 6 such as the Internet into the portable device (1002). The portable device 7 notifies the portable device company server 4 of the URL information (1003) and makes access to the search server 2 via the communication network 6 such as the Internet (1004).

The search server 2 which has been accessed by the portable device company server 4 returns the service contents regarding to the electronic data delivery service and the registration number corresponding to the service contents together (1005).

The portable device company server 4 which has received the service contents and the registration number corresponding to the service contents from the search server sends the deliverable service information of the electronic data to the portable device 7 (1006).

The portable device 7 which has received the deliverable service information of the electronic data displays the sent service contents and the registration number corresponding to the service together on the LCD display unit 604 (1007).

Next, when the desired electronic data is contained in the service contents sent from the search server, the user operates the operation button 605 of the portable device 7 to input the corresponding registration number (1008).

Next, the portable device 7 sends the registration number input by the user to the portable device company server 4 (1009), and the portable device company server 4 sends the registration number using the URL of the search server via the communication network 6 such as the Internet (1010).

The search server 2 which has received the service registration number from the portable device company server 4 searches the information of the delivery server 3 providing the service from the received registration number. The search server 2 reads the delivery server information corresponding to the service registration number stored therein.

The URL information of the delivery server 3 providing the service is accumulated in the search server. The search server 2 detects the URL information of the delivery server 3 from the searched information, and then sends an inquiry about the service presence to the delivery server 3 via the Internet network 6 or the like (1011).

The delivery server 3 which has received the inquiry about the service presence form the search server 2 returns a message that the information delivery is available, and further returns charge information required for the information delivery (1012).

The search server 2 which has received the message that the delivery service is available from the delivery server 3 notifies the portable device company server 4 that the information delivery service is available (1013).

Next, the portable device company server 4 notifies the portable device 7 that the information delivery service is available (1014).

The portable device 7 which has been notified that the delivery service is available from the portable device company server 4 outputs a message that the information is available to the user on the LCD display unit 604 (1015).

When the user operates the operation button 605 of the portable device 7 to input a message that the user continues the utilization operation of the delivery service (1016), the portable device 7 subsequently notifies the portable device company server 4 that the user continues the utilization operation of the delivery service (1017).

Next, the portable device company server 4 requests the personal information sending to the portable device 7 (1018), and reads the phone number of the portable device stored in the internal ROM 609 or the ID individually managed per portable device (1019).

The portable device company server 4 receives the sent information stored in the ROM 609 in the portable device, and then inquires the personal information to confirm whether or not the user is a person regally registered in the portable device company.

After it is confirmed that the portable device 7 is registered in the portable device company, the fee for delivering the electronic data from the delivery server 3 is transferred to the bank account of the magazine company which manages and operates the delivery server or the provider which intends to place the advertisement or information on a medium such as magazine.

The fee which the portable device company has transferred to the magazine company which manages and operates the delivery server or the provider which intends to place advertisements or information on a medium such as magazine is charged as a portable device service utilized by the user, and is transferred later from the user to the company which operates the portable device service. As described above, at the stage of the charge process completion in the portable device company, the portable device company server 4 notifies the search server 2 of the charge process completion (1020).

Next, the search server 2 notifies the delivery server 3 of the charge process completion via the Internet network 6 or the like, and requests to continue the electronic data delivery service (1021).

The delivery server 3 which has received the charge process completion for the delivery service generates a password for permitting the electronic data stored in the delivery server 3 to be transferred via the Internet network 6 or the like, and sends this password information to the search server 2 (1022).

Moreover, in order that to specify the user who has performed a series of operations when the delivery server issues the password, the delivery server issues an arbitrarily assigned ID to specify the user who has utilized the service by this ID on the delivery server. The delivery server 3 sends this ID information in addition to the password to the search server 2. The search server 2 which has received the password information retransfers the password to the portable device company server 4 (1023).

The portable device company server 4 which has received the password transfers the password information and a communication log between the search server, the delivery server, and the portable device company server to the user's portable device 7 (1024).

After the MFP system transfers a series of information including the password to the use's portable device, the portable device 7 notifies the portable device company server 4 of the information reception (1025). Next, the portable device 7 outputs a message that all the processes have been completed to the LCD display unit 604 (1026), and the user instructs the portable device 7 to disconnect the line with the portable device company server 4, and completes all the operations (1027).

Next, description will be made in detail on the case where the user transfers the electronic data from the delivery server 3 to the MFP 11 of the MFP system shown in FIG. 1.

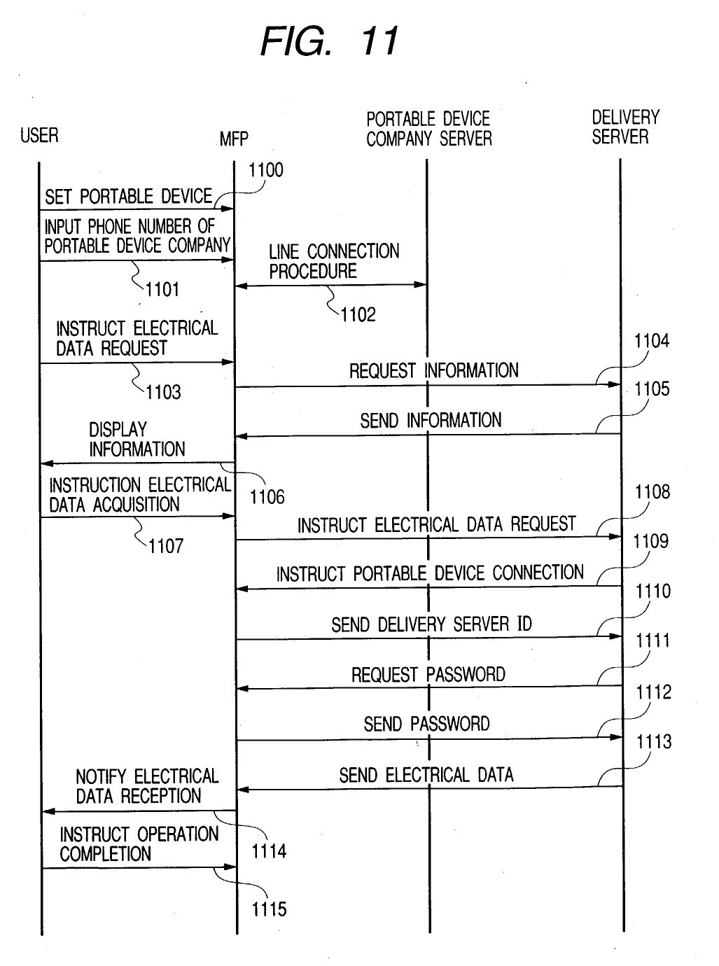

FIG. 11 is shown for explaining an outline of the operation where the electronic data of the information desired by the user is transferred from the delivery server 3 to the MFP 11 of the MFP system shown in FIG. 1 in the second embodiment according to the present invention.

First, the user sets the portable device 7 in the MFP 11 of the MFP system 1 installed in a convenience store or the like (1100).

The MFP 11 in which the portable device 7 is set is available for acquiring the information of the RAM 607 and the ROM 609 in the portable device 7 via the external expansion I/F 603 of the portable device 7. Also, it is possible to make communication with the outside using the digital telephone line via the phone unit 602. Next, the user inputs the phone number of the portable device company to make connection to the portable device company server 4 (1101).

The portable device 7 whose phone number has been input performs a procedure for connecting a predetermined line with the portable device company server 4 (1102) and completes the line connection.

Next, the user operates the MFP 11 to output the information acquired when requesting the delivery service before being stored in the RAM 607 in the connected portable device 7 on the monitor 12 connected to the MFP 11. Subsequently, the user operates the MFP 11 to select the name of the desired delivery service from among the names of the deliver services displayed on the monitor 12 (1103).

The MFP 11 in which the name of the delivery service has been selected reads the URL information of the delivery server 3 shown in FIG. 7 which is stored in the RAM 607 in the portable device 7, and uses the phone unit 602 in the portable device 7 to make access to the delivery server via the communication network 6 such as the Internet through the portable device company server 4 (1104).

The accessed delivery server 3 sends the public information, in particular the delivery service information of the electronic data via the communication network 6 such as the Internet, the portable device company server 4, and the portable device 7 to the MFP 11 (1105). The MFP 11 outputs the information received from the delivery server 3 on the monitor 12 to prompt the user to continue the operation (1106).

Next, the user operates the MFP 11 to request the electronic data delivery on the basis of the information output on the monitor 12 connected to the MFP 11 (1107).

The MFP 11 which has received the delivery data reception request from the user requests the electronic data delivery via the portable device 7, the portable device company server 4, and the communication network 6 such as the Internet to the delivery server 3 (1108). The delivery server 3 which has been requested the electronic data delivery requests the portable device connection to the MFP 11 which has requested the electronic data (1109).

Here, the user's portable device 7 is in the state of being connected to the MFP 11, and the MFP 11 searches the name 71 of the electronic data which is stored on the RAM 607 in the portable device and which is the delivery service target shown in FIG. 7.

The MFP 11 which has searched the name of the electronic data which is the delivery service target reads the ID information (76) subsequently written which the delivery server 3 has arbitrarily assigned, and transmits the ID information (76) via the communication network 6 such as the Internet to the delivery server 3 (1110).

The delivery server 3 which has received the ID information (76) confirms the history of the ID issued before being stored in the delivery server 3, and confirms the password corresponding to the ID so as to perform the password request to the MFP 11 (1111).

The MFP 11 which has been requested the password from the delivery server 3 reads the password (76) from the RAM 607 in the connected portable device to transmit it to the delivery server 3 (1112).

The delivery server 3 which has received the password from the MFP 11 collates with the password corresponding to the ID information (76) and stored in the delivery server 3 as described above. When the password matches, the electronic data is transmitted via the communication network 6 such as the Internet, the portable device company server 4, and the portable device 7 to the MFP 11 (1113).

The MFP 11 which has completed the electronic data reception from the delivery server 3 notifies the monitor 12 of the electronic data reception completion (1114), and the user notifies the MFP 11 of the operation completion and completes all the operations (1115).

In such a manner, according to the present embodiment, the user can cause the electronic data delivery operation to be performed without being conscious of the password information, and further, even when the MFP system in FIG. 1 is not connected over the communication network such as the Internet, it is possible to deliver the electronic data and the like using the portable device possessed by the user.

According to the present embodiment, the user can cause the electronic data delivery operation to be performed without being conscious of the information such as the password.

Further, the user can automatically acquire the delivery information without being conscious of the name of the electronic data for acquiring the delivery information or the operation request for the delivery server.

Furthermore, the user uses the electronic data delivery information once input in the user's portable terminal so that it is possible to download the electronic data desired by the user from anywhere by utilizing all the things which are connectable with the portable device and are connected to the communication network such as the Internet without performing complicated authentication process.

(Third Embodiment)

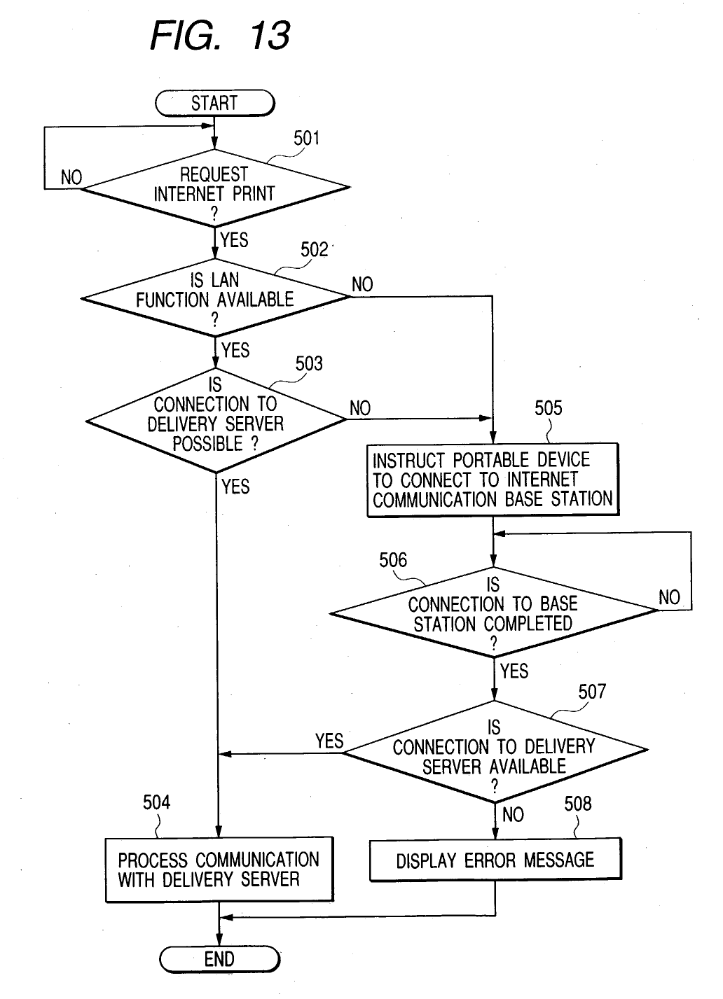

FIG. 13 is a flow chart showing the case where a CPU 310 of the printer unit in FIG. 3 detects first the network connection state when the user operates the MFP system installed in a convenience store or the like to acquire the electronic data stored in the delivery server 3 connected over the communication network 6 such as the Internet and to output it to a recording medium such as sheet from the printer unit of the MFP system according to the embodiment shown in FIG. 1.

First, the CPU 310 waits until a request of printing out the electronic data in the delivery server over the Internet reaches from the user (501). Next, when the request of printing out the electronic data in the delivery server over the Internet reaches, the CPU 310 determines whether a network interface controller 311 in FIG. 3 is mounted or whether it can normally operate by reading a register in the network interface controller 311 (502). When it is confirmed that the network interface controller 311 is mounted, the CPU 301 tries to access the URL of the delivery server 3 connected over the communication network 6 such as the Internet, which records therein the electronic data designated by the user (503). The CPU 301 determines that the access to the delivery server 3 has been normally made, it processes to receive the electronic data stored in the delivery server described later (504) and completes all the processes. When it is confirmed in 502 that the network interface controller 311 is not mounted on the CPU 310 or that it does not operate normally, the mode is switched to utilize the communication function of the portable device 7 connected to the MFP 11. The portable device 7 is connected thereto via an expansion I/O interface 316.

The portable device 7 is connected to the MFP 11 via the expansion I/O interface 316 and can read the information stored in the RAM 607 and the ROM 609 in the portable device from the CPU 301. When the mode is switched to a mode for utilizing the communication function of the portable device 7 connected to the MFP 11, the CPU 310 first operates the portable device 7 via the expansion I/O interface 316 to call the server performing the service connectable to the communication network 6 such as the internet from the portable device 7 (505). The CPU 301 waits until it is connected to the server performing the service connectable to the communication network 6 such as the Internet (506). The CPU 301 which has been notified the connection completion to the server performing the service connectable to the communication network 6 such as the Internet tries to access the URL of the delivery server 3 connected over the communication network 6 such as the Internet, which records therein the electronic data designated by the user, via the portable device 7 and the server performing the service connectable over the communication network 6 such as the Internet (507).

Here, when the CPU 301 determines that the access to the delivery server 3 has been normally made, it processes to receive the electronic data stored in the delivery server described later (504), and completes the all the processes. Alternatively, in the case where the access to the URL of the delivery server 3 connected over the communication network 6 such as the Internet which records the electronic data designated by the user has not been made normally, the fact that the communication is not available is output as an error message to the CRT 12 or the like in FIG. 1, and all the processes are completed.

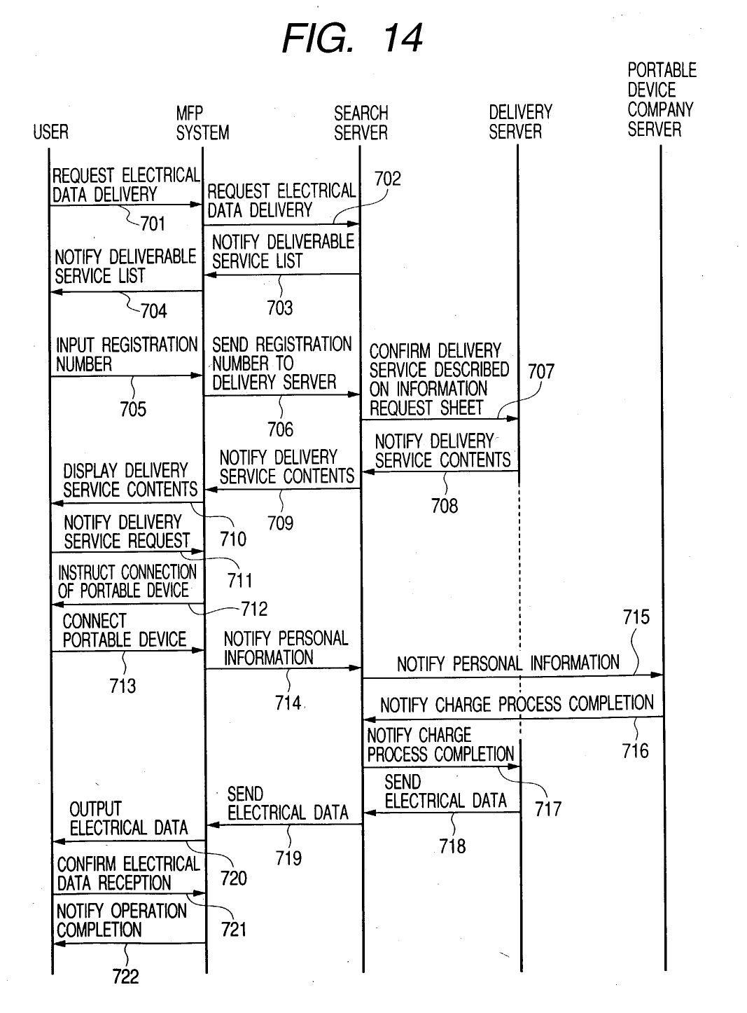

FIG. 14 is shown for explaining an outline of the Operation where the user uses the MFP system 1 in FIG. 1 installed in a convenience store or the like, utilizes the search server 2 connected over the communication network 6 such as the Internet to search the delivery server 3 which accumulates the electronic data of the information desired by the user therein, and is charged the utilization fee for receiving the information on the portable device company server so as to acquire the password for acquiring the electronic data.

The user operates the MFP to input the deliverable service contents using the MFP at a place such as convenience store where the MFP system 1 in FIG. 1 is installed (701).

Next, it is assumed that the CPU 301 incorporated in the printer unit of the MFP 11 performs process shown in FIG. 5, it can be confirmed that the network interface controller 311 is mounted on the CPU 301, and the MFP 11 can directly send and receive data via the communication network 6 such as the Internet to the delivery server 3 connected over the communication network 6 such as the Internet which records therein the electronic data designated by the user.

The MFP which has received an inquiry about the deliverable service of the electronic data from the user inquires for the search server 2 shown in FIG. 1 (702).

When the magazine company or the provider which intends to place advertisements or information on a medium such as magazine places the aforementioned key code on a medium such as magazine in order to provide more detailed information or high degree services utilizing the environment such as the Internet, an application is at first performed for the organization which manages the search server 2 in FIG. 1. Thereby, the organization which manages the search server 2 in FIG. 1 issues a service registration number for identifying the services provided on the environment such as the Internet by the magazine company or the provider which intends to place the advertisements or information on a medium such as magazine.

When an inquiry about the delivery service of the electronic data is made from the MFP installed in a convenience store or the like, the search server returns the service contents and this registration number together (703).

The MFP which has received the service contents and this registration number from the search server displays the sent service contents and the registration number corresponding to the service on the monitor 12 or the like in FIG. 1 (704).

Next, when the desired electronic data is contained in the service contents sent from the search server, the user operates the MFP to input the corresponding registration number (705).

Next, the MFP 1 sends the registration number input by the user to the search server 2 via the environment such as the Internet network 6 in FIG. 1 using URL of the search server (706).

The search server 2 which has received the service registration number from the MFP 1 searches the information of the delivery server 3 providing the service from the received registration number. The search server 2 reads the delivery server information corresponding to the service registration number stored therein. The URL information of the delivery server 3 providing the service or the like is accumulated in the search server, and the search server 2 detects the URL information of the delivery server 3 from the searched information, and then sends an inquiry about the service presence to the delivery server 3 via the Internet network 6 or the like (707).

The delivery server 3 which has received the inquiry about the service presence from the search server 2 returns a message that the information delivery is available, and further returns the charge information required for the information delivery (708).

The search server 2 which has received the message that the delivery service is available from the delivery server 3 notifies the MFP system 11 that the information delivery service is available (709).

The MFP 1 which has been notified that the delivery service is available from the search server 2 outputs a message that the information is available to the user on the monitor 12 in FIG. 1 (710).

When the user operates the MFP 1 to input a message that he/she will continue the utilization operation of the delivery service (711), the MFP 1 outputs a screen for requesting the user to mount the user's portable device on the MFP 1 on the monitor 12 (712).

When the user connects the portable device to the MFP 1 according to the instruction of the MFP 1, the MFP 1 reads the phone number of the portable device stored in the ROM 609 in the connected portable device or the ID individually managed per portable device.

Further, at this time, the information on the company which manages and operates the portable device service is also extracted simultaneously (713).

At this time, it is possible to mount a scanner for reading a fingerprint on the external expansion I/F 603 of the portable device and to send the personal fingerprint information with the personal data.

The personal information which is read by the MFP 1 and stored in the portable device is transferred to the search server 2 via the Internet network 6 or the like, and the information on the company which manages and operates the portable device service is also transferred (714), and the URL information of the server performing the portable device service is searched on the basis of this information. The search server 2 sends the personal information acquired from the portable device from the searched URL via the Internet network 6 or the like to the portable device company server, and inquires the personal information to confirm whether or not the user is a person regally registered in the portable device company (715).

At this time, when the scanner for reading a fingerprint has been attached to the external expansion I/F 603, the personal fingerprint information has been also received so that it is possible to specify the person with both the portable device information and the fingerprint information. After it is confirmed that the user has been registered in the portable device company of the portable device, the fee for delivering the electronic data from the delivery server 3 is charged for the portable device company server. The portable device company is notified the information of the delivery server connected over the Internet network 6 from the search server 2 and receives the charge information when utilizing the service provided by this delivery server, and then transfers the utilization fee for the service to the bank account of the magazine company which manages and operates the delivery server or the provider which intends to place advertisements or information on a medium such as magazine. The fee which the portable device company has transferred to the magazine company which manages and operates the delivery server or the provider which intends to place advertisements or information on a medium such as magazine is charged as a portable device service utilized by the user and is transferred later to the bank account of the company which operates the portable device server from the user.

As described above, at the stage of the charge process completion in the portable device company, the portable device company server 4 notifies the search server 2 of the charge process completion (716).

Next, the search server 2 notifies the delivery server 3 of the charge process completion via the Internet network 6, and requests to continue the electronic data delivery service (717). The delivery server 3 which has received the charge process completion for the delivery service sends the electronic data stored in the delivery server to the search server 2 (718).

Further, the delivery server 3 resends the electronic data to the MFP 11 (719).

The MFP 11 which has received the electronic data sends the electronic data to the printer unit 307 in FIG. 3, and forms an image to output it to a recording medium such as sheet (720).

After the MFP system completes the entire image outputting, the user operates the MFP 11 to notify the electronic data reception for confirmation (521), and outputs the message that all the processes have been completed on the monitor 12, and completes all the operations (522).

As described above, according to the present embodiment, when the MFP is used to receive the electronic data from the communication network such as the Internet, even if the user does not determine whether or not the MFP is connected to the communication network such as the Internet, the MFP can automatically determine it so that the user can avoid the complicated process.

Further, when the user can automatically acquire the delivery information without being conscious of the name of the electronic data for acquiring the delivery information or the operation request for the delivery server.

The search server 2 or the information delivery server 3 according to the present embodiment may be a typical computer.

(Fourth Embodiment)

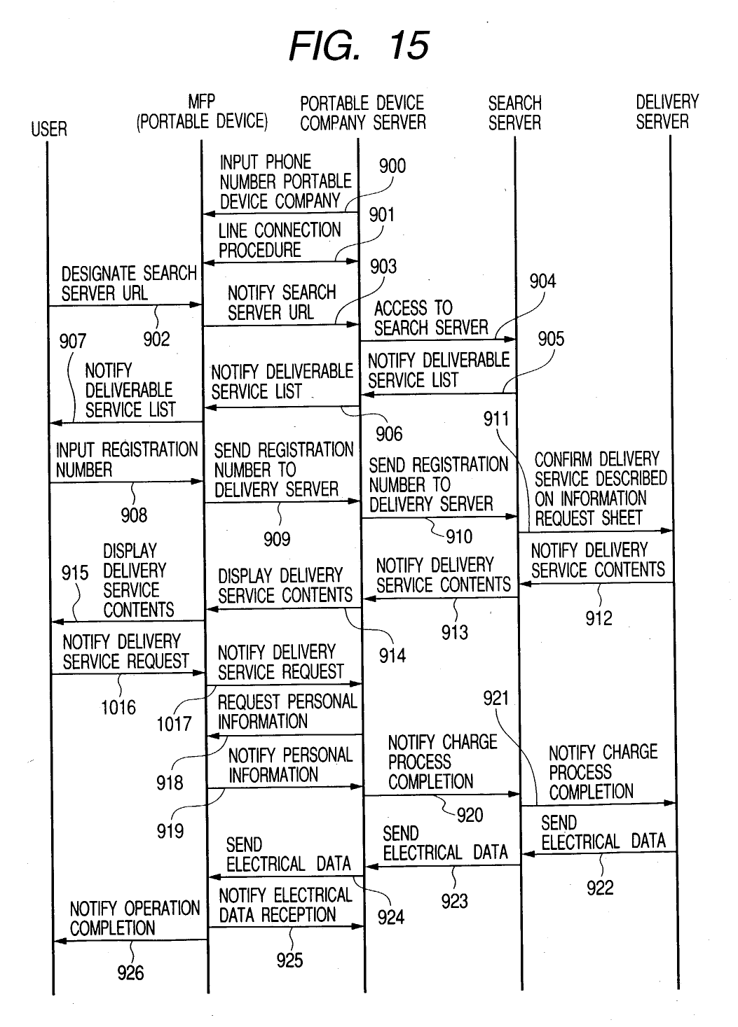

FIG. 15 is shown for explaining an outline of the operation where the user uses the portable device 7 to communicate with the portable device company server 4 utilizing a digital telephone line, uses the search server 2 via the communication network 6 such as the Internet to search the delivery server 3 which accumulates the electronic data of the information desired by the user therein, and further is charged the utilization fee for receiving the information on the portable device company server so as to acquire the electronic data according to the embodiment of the present invention shown in FIG. 9.

First, the user connects the portable device to the MFP 11, and then operates the MFP 11 to acquire the electronic data from the delivery server 3 connected over the communication network 6 such as the Internet, and instructs to output it on a recording medium such as sheet. The CPU 301 of the printer unit in the MFP 11 processes according to the flow in FIG. 13 as described above, determines that the direct connection to the communication network 6 such as the Internet is not available, and changes the mode to connect to the communication network 6 such as the Internet using the portable device 7.

First, the MFP 11 operates the portable device 7 via the expansion interface I/O 316 to connect to the portable device company server 4 (900). The portable device 7 performs the procedure for connecting a predetermined line with the portable device company server 4 (901), and completes the line connection. Next, the user inputs the URL of the search server 2 connected over the communication networks 6 such as the Internet into the portable device (902). The portable device 7 notifies the portable device company server 4 of the URL information (903), and the portable device company server 4 makes access to the search server 2 via the communication network 6 such as the Internet (904).

The search server 2 which has been accessed by the portable service company server 4 returns the service contents and the registration number corresponding to the service contents regarding to the electronic data delivery service (905).

The portable device company server 4 which has received the service contents and the registration number corresponding to the service contents from the search server sends the deliverable service information of the electronic data via the portable device 7 to the MFP 11 (906). The MFP 11 which has received the deliverable service information of the electronic data displays the sent service contents and the registration number corresponding to the service on the CRT 12 (907).

Next, when the desired electronic data is contained in the service contents sent from the search server, the user operates the MFP 11 to input the corresponding registration number (908).

Next, the MFP 11 sends the registration number input by the user via the portable device 7 to the portable device company server 4 (909), and further the portable device company server 4 uses the URL of the search server to send the registration number via the communication network 6 such as the Internet (910).

The search server 2 which has received the service registration number from the portable device company server 4 searches the information of the delivery server 3 providing the service from the received registration number.

The search server 2 reads the delivery server information corresponding to the service registration number stored therein. The URL information of the delivery server 3 providing the service or the like is accumulated in the search server. After the search server 2 detects the URL information of the delivery server 3 from the searched information, it sends an inquiry about the service presence to the delivery server 3 via the Internet network 6 or the like (911).

The delivery server 3 which has received the inquiry about the service presence from the search server 2 returns a message that the information delivery is available, and further returns the charge information required for the information delivery (912).

The search server 2 which has received the message that the delivery service is available from the delivery server 3 notifies the portable device company server 4 that the information delivery service is available (913).

Next, the portable device company server 4 notifies the MFP 11 that the information delivery service is available via the portable device 7 (914).

The MFP 11 which has been notified that the delivery service is available from the portable device company server 4 outputs a message that the information is available to the user on the CRT 12 (915).

When the user operates the MFP 11 to input a message that the user will continue the utilization operation of the delivery service (916), the MFP subsequently notifies the portable device company server 4 that the user will continue the utilization operation of the delivery service (917).

Next, the portable device company server 4 requests the personal information sending to the MFP 11 (918).

Here, the MFP 11 reads the phone number of the portable device stored in the ROM 609 in the connected portable device 7 or the ID individually managed per portable device, and sends it to the portable device company server 4 (919).

The portable device company server 4 receives the sent information stored in the ROM 609 in the portable device, and then inquires the personal information to confirm whether the user is a person regally registered in the portable device company. After it is confirmed that the portable device 7 has been registered in the portable device company, the fee for delivering the electronic data from the delivery server is transferred to the bank account of the magazine company which manages and operates the delivery server or the provider which intends to place advertisements or information on a medium such as magazine.

The fee which the portable device company has transferred to the bank account of the magazine company which manages and operates the delivery server or the provider which intends to place advertisements or information on a medium such as magazine is charged as a portable device service utilized by the user, and is transferred later to the bank account of the company which operates the portable device service from the user. At the stage of the charge process completion in the portable device company as described above, the portable device company server 4 notifies the search server 2 of the charge process completion (920).

Next, the search server 2 notifies the delivery server 3 of the charge process completion via the Internet network 6 or the like, and requests to continue the electronic data delivery service (921).

The delivery server 3 which has been received the charge process completion for the delivery service sends the electronic data stored in the delivery server to the search server 2 (922).

The delivery server 3 retransfers the electronic data to the portable device company server 4 (923). The portable device company server 4 which has received the electronic data further retransfers the electronic data to the MFP 11 (924).

After receiving the electronic data, the MFP 11 notifies the portable device company server 4 of the information reception (925), sends the electronic data to the printer unit 307 in FIG. 3, and forms an image on a recording medium such as sheet to output it. Next, the MFP 11 outputs a message that all the processes have been completed to the CRT 12 (926), and completes all the operations.

As described above, according to the present embodiment, when the MFP is used to receive the electronic data from the communication network such as the Internet, even when the user does not determine whether or not the MFP is connected to the communication network such as the Internet, the MFP can automatically determine it. Even when the MFP cannot be connected to the communication network such as the Internet, the user can change the mode to automatically communicate the data via the user's portable device without the complicated process. Further, the user can automatically acquire the delivery information without being conscious of the name of the electronic data for acquiring the delivery information or the operation request for the delivery server.

(Other Embodiment)

The present invention may be applied to a system configured of a plurality of devices (for example, host computer, interface device, reader, printer, and the like), or to an apparatus configured of a single device.

Further, it goes without saying that an object of the present invention is achieved by supplying a recording medium having a program code of a software for realizing the functions of the aforementioned embodiments recorded therein to a system or a device, and reading the program code stored in the recording medium by a computer (or CPU or MPU) of the system or the device.

In this case, the program code itself read from the recording medium realizes novel functions of the present invention so that the recording medium having the program code stored therein configures the present invention. The storage medium for supplying the program code may employ, for example, flexible disk, hard disk, optical disk, magnet-optical disk, CD-ROM, CD-R, magnetic tape, nonvolatile memory card, ROM, and the like.

Further, it goes without saying that not only the program code read by the computer is executed so as to realize the functions of the aforementioned embodiments, but also the operating system running on the computer performs part of or all the actual processes on the basis of the instruction of the program code so as to realize the functions of the aforementioned embodiments.

In addition, it goes without saying that, after the program code read from the recording medium is written into a memory provided in a function expansion board inserted into the computer or a function expansion unit connected to the computer, the CPU provided in the function expansion board or the function expansion unit performs part of or all the actual processes so as to realize the functions of the aforementioned embodiments.

According to the above embodiments, whether an information output device (means) installed in a convenience store or the like is connected to a network, it is possible for the user to automatically grasp the connection state to the network without complicated process, and to select whether to send or receive the data using the network function of the information output device (means) or utilizing the communication function of the user's portable device.

What is claimed is:

1. An information providing system capable of sending and receiving electronic data from a server in which the electronic data is registered, comprising:
delivering means for delivering electronic data registered in the server;
connecting means for connecting a portable device possessed by an individual to a communication network for communicating electronic information;
sending means for sending information for identifying an individual stored in the portable device;
authenticating means for receiving the information for identifying an individual sent from the sending means, and determining whether or not the delivering means is available to a user; and
registering means for receiving a password or ID information required when a user acquires electronic data by the delivering means, and registering the password or ID information in the portable device possessed by the individual.

2. An information providing system according to claim 1, wherein a password or ID information registered, by the registering means, in the portable device possessed by the individual is sent to the delivering means by the sending means, and the system comprises delivery permission determining means for permitting a user to acquire delivery data from the delivering means.

3. An information providing system according to claim 1, comprising electronic data acquiring means to which a user connects the portable device and which is used for. acquiring electronic data from the delivering means.

4. An information providing system according to claim 1, comprising a readable/writable memory into which information for identifying an individual is stored and new information can be written in the portable device possessed by the individual.

5. An information providing system according to claim 4, comprising inquiring means for managing information for identifying an individual stored in the memory present in the portable device per portable device, and for, when an inquiry occurs via the communication network, inquiring the information for identifying an individual according to the inquiry.

6. An information providing system according to claim 1, comprising searching means for searching the delivering means in which electronic data desired by a user is recorded over the communication network.

7. An information providing system according to claim 6, wherein the searching means comprises inputting means for inputting information regarding to electronic data which is used for searching electronic data desired by a user, and outputting means for outputting information sent from the delivering means and the searching means to a user, and displaying information stored in the portable device possessed by the individual.

8. An information providing method for sending and receiving electronic data from a server in which the electronic data is registered, comprising:
a delivering step of delivering electronic data registered in the server;
a connecting step of connecting a portable device possessed by an individual to a communication network for communicating electronic information;
a sending step of sending information for identifying an individual stored in the portable device;
an authenticating step of receiving the sent information for identifying an individual, and determining whether or not the information is available to a user; and
a registering step of receiving a password or ID information required when a user acquires electronic data, and registering the password or ID information in the portable device possessed by the individual.

9. A computer readable storage medium having a program for realizing each means in the information providing system according to claims 1 to 7 and each step of the information providing method according to claim 8 stored therein.

10. An information providing system capable of sending and receiving electronic data via a communication network for communicating electronic information, comprising:
switching means for connecting a portable device connectable to the communication network to information outputting means capable of outputting information;
deciding means for deciding whether or not the information outputting means is directly connectable to the communication network; and
changing means for, when the deciding means decides that the information outputting means is directly connected to the communication network, acquiring electronic data from the communication network, and for, when the deciding means decides that the information outputting means is not directly connected to the communication network, switching a mode to acquire electronic data from the communication network via the portable device.

11. An information providing system according to claim 10, wherein the searching means comprises inputting means for inputting information regarding to electronic data which is used for searching electronic data desired by a user, and
outputting means for outputting information sent from the delivering means and the searching means to a user, and displaying information stored in the portable device possessed by the individual.

12. An information providing system according to claim 11, comprising local communicating means for connecting the connecting means, and the inputting means and the outputting means with each other.

13. An information providing method for sending and receiving electronic data via a communication network for communicating electronic information, comprising:
a connecting step of connecting a portable device to information outputting means;
a deciding step of deciding whether or not the information outputting means is directly connectable to the communication network; and,
a switching step of, when it is decided that the information outputting means is directly connected to the communication network, acquiring electronic data from the communication network, and for, when it is determined that the information outputting means is not directly connected to the communication network, switching a mode to acquire electronic data from the communication network via the portable device.

14. A computer readable storage medium having stored therein a program for performing a function of each means in the information providing system according to claims 1 to 7 and 10 to 12, and each step of the information providing method according to claims 8 and 13.

15. A program for performing a function of each means in the information providing system according to claims 1 to 7 and 10 to 12, and each step of the information providing method according to claims 8 and 13 in a computer.
